(19) United States
(12) Patent Application Publication
(10) Pub. No.: US 2010/0244305 A1
(43) Pub. Date: Sep. 30, 2010

(54) METHOD OF MANUFACTURING A POLYMERIC STENT HAVING IMPROVED TOUGHNESS

(76) Inventors: Joseph H. Contiliano, Stewartsville, NJ (US); Qiang Zhang, Annandale, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/410,143

(22) Filed: Mar. 24, 2009

(51) Int. Cl. B28B 1/48

(52) U.S. Cl. 264/154; 264/234; 264/163

(57) ABSTRACT

Methods of manufacturing polymeric intraluminal stents are disclosed. Specifically, a method of manufacturing polymeric intraluminal stents by inducing molecular orientation into the stent by radial expansion.

### FIELD OF THE INVENTION

The present invention relates to a method of manufacturing polymeric intraluminal stents, and more particularly to polymeric intraluminal stents.

### BACKGROUND OF THE INVENTION

Intraluminal stents are known and are typically cylindrical shaped devices implanted within a body lumen in an initial configuration having a reduced diameter and then radially expanded with the application of force to a second configuration having a larger size. The expansion is typically done with a balloon catheter. After expansion, the intraluminal stent acts as a support member by providing an outwardly directed radial force to the vessel walls to maintain patency of the lumen. The stent should possess a certain degree of flexibility to be maneuvered through tortuous vascular pathways and conform to nonlinear vessel walls when expanded. When expanded an intraluminal stent should exhibit certain mechanical characteristics. These characteristics include maintaining vessel patency through an acute and/or chronic outward force that will help to remodel the vessel to its intended luminal diameter, preventing excessive radial recoil upon deployment, exhibiting sufficient fatigue resistance and exhibiting sufficient ductility so as to provide adequate coverage over the full range of intended expansion diameters.

It is well known in the art that molecular orientation, or the induction of polymer chain alignment can enhance the material properties such as strength and toughness. Molecular orientation is typically achieved by heating the material above the glass transition temperature, Tg, of the material, applying force to the material, and then cooling the material to below the Tg.

Polymeric stents are known that are expanded radially outward through the facilitation of heat applied to the stent to raise the temperature of the stent to above the Tg of the material thus inducing molecular orientation in the stent in situ (during deployment). In some embodiments, the polymer of the stent may have a Tg at or below body temperature. Polymer blend systems, such as that containing trimethylene carbonate or poly(epsilon-capralactone), which contain a lower Tg are also known. These compositions typically result in a stent material with lower modulus and strength and can exacerbate recoil when used in the body above their Tg. Heating the stent to affect deployment is not desirable since it requires an additional step to the surgical procedure, may introduce procedural variabilities between surgeons, and can risk thermal damage to body tissues.

Various methods of using axially, radially, and biaxially oriented tubing to create stents with enhanced material properties are known in the art. For example, known methods of using tubing produced via various means including melt processing and solvent casting methods, orienting the tubing by various means to affect and enhance material properties, and then creating stents from said tubing. Orientation in one direction can enhance material properties in that direction while also compromising material properties in the orthogonal direction. By orienting the tubing prior to cutting the stent, the molecular orientation and hence the enhancement of material properties is created along the axes (typically longitudinal and/or circumferential) of the tubing used to create the stent, not necessarily in the appropriate directions for the stent itself.

As is well known in the art, stents are typically composed of various interconnecting strut and bridging architectures in geometric relation to one another to allow for stent unfolding, the struts themselves do not necessarily lie directly along the axes of the tubes from which they are manufactured. Hence the actual stent properties resulting from orientation depend largely on the particular stent configuration and even various stent configurations cut from the same oriented tube may have different stent properties due to the molecular alignment. Thus there is a challenge to identify the optimum degree of orientation in various directions for each specific stent configuration.

Many stent configurations known in the art with unfolding strut architectures have regions in the strut scaffolding where stresses and strains are more concentrated, typically in hinge regions between adjacent struts. The more central regions of struts in fact may experience generally little or no stress. Therefore, it may be desirable to provide molecular orientation and thus material property enhancement only in those regions of the stent configuration that actually require or use the enhanced property in their intended application. There is a need in this art of novel methods of making stents with enhanced properties for which known molecular orientation is induced to follow the stent configuration and where the stent configuration itself controls where molecular orientation occurs and for novel stents having such properties.

### SUMMARY OF THE INVENTION

Accordingly, novel manufacturing processes for intraluminal stents are disclosed. The novel method of the present invention is a method of manufacturing polymeric intraluminal stents wherein a stent is first produced from polymer tubing and then the properties of said stent, such as strength, elongation at break, and toughness are enhanced by inducing molecular orientation in the stent. The process disclosed provides a means to affect with some degree of specificity based on the configuration, the degree and location of molecular orientation in the final part based on how the particular stent is intended to expand in the body.

Another aspect of the present invention are novel stents manufactured according to the above described process and having the properties described where enhanced properties are provided through molecular orientation in stent regions as determined by the particular stent geometry

Another aspect of the present invention is a method of maintaining the patency of a blood vessel by inserting a stent of the present invention and expanding the stent in the blood vessel.

The novel stents of the present invention manufactured from polymeric materials using the novel manufacturing process have many advantages that include providing polymeric intraluminal stents that contain enhanced properties due to molecular orientation only in certain regions of the stent geometry where strains are occurring during balloon deployment.

The foregoing and other features and advantages of the invention will be apparent from the following description and accompanying drawings.

### BRIEF DESCRIPTION OF THE DRAWINGS

FIG. 1 illustrates an exemplary stent of the present invention fabricated by the methods in accordance with the invention.

FIG. 2 illustrates a portion of a stent of the present invention having nine circumferential ring sections or members (vertical elements) connected via straight bridge members (horizontal elements).

FIG. 3 is a perspective view of a section of the stent of in FIG. 2, showing four circumferential ring sections or members connected to adjacent ring sections by three bridge elements in an alternating fashion.

FIG. 4 is a perspective view of a section of a stent of the present invention showing three circumferential ring sections or members, each with three strain localization regions per ring member, connected to adjacent ring sections by three bridge elements or members in an alternating fashion.

FIG. 5 is a microscopic image of a stent having a configuration as shown in FIG. 2 that has been expanded at body temperature.

FIG. 6 illustrates a portion of a stent of the present invention showing nine circumferential ring sections or members (vertical elements) with a wave configuration connected via straight bridge members (horizontal elements).

FIG. 7 is a perspective view of a portion of the stent of in FIG. 6 showing six circumferential ring sections or members with a wave configuration connected to adjacent ring members by three bridging elements in an alternating fashion.

### DETAILED DESCRIPTION OF THE INVENTION

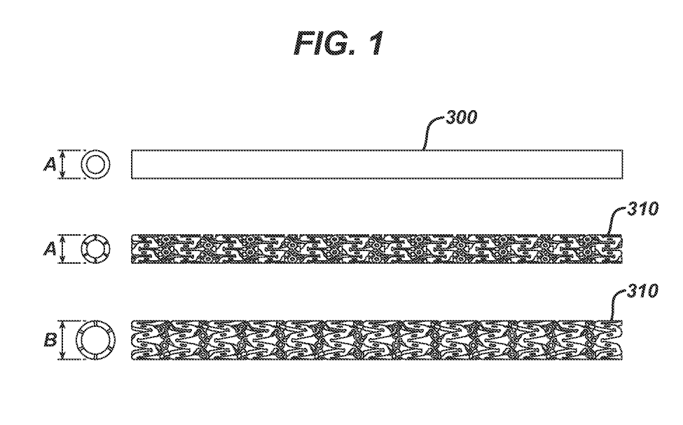

In one embodiment, the present invention provides a method of manufacturing polymeric intraluminal stents. In one embodiment of the method of the present invention as seen in FIG. 1, the polymeric intraluminal stents are prepared by providing a polymer tubing 300 having a diameter A. The polymer tubing is then processed as described herein and/or using conventional techniques to obtain a stent 310 having a first diameter A. The stent 310 having diameter A is then expanded radially to a second diameter B, larger than diameter A, thereby inducing molecular orientation in the stent 310. Diameter B is less than the final diameter C (not shown) of the polymeric intraluminal stent 310 upon deployment and expansion in the lumen of a body vessel. Optionally, the stent 310 having a diameter B may undergo further processing such as annealing to promote product stability, or crimping on a delivery apparatus, which may further lower diameter prior to insertion in the body and expansion to diameter C.

In another embodiment as also illustrated in FIG. 1, a polymeric intraluminal stent 310 is provided having a diameter A. The stent having diameter A is then expanded radially to a stent 310 having a diameter B, thereby inducing molecular orientation in the stent 310. Diameter B is less than the final diameter C of the polymeric intraluminal stent upon deployment and expansion in the lumen of a body. Optionally, the stent 310 having a diameter B may undergo further processing such as annealing to promote product stability, or crimping on a delivery apparatus, which may further lower diameter prior to insertion in the body and expansion to diameter C.

The method of manufacturing intraluminal stents described herein produces polymeric stents with enhanced material properties as a result of molecular orientation induced in the stent by radial expansion. Moreover, since the molecular orientation is induced in the stent after the stent architecture has been produced, the location and degree of orientation is dependent and in large part dictated by the requirements of the specific stent configuration. An advantage of the disclosed method is that it does not depend on the specific stent configuration utilized and those skilled in the art will soon recognize that the process is applicable in similar manner to various stent configurations known in the art.

The polymer tubing that is provided may be prepared by conventional methods such as extrusion, injection molding, and solvent casting. The desired polymer tubing diameter and wall thickness are dependent on the final diameter of the stent, which is in turn dependent on the diameter of the body lumen in which the stent will be deployed. One of skill in the art will be able to determine the appropriate polymer tubing diameter and wall thickness with the benefit of the invention described herein.

Semi-crystalline polymers have two thermal transitions; namely, the crystal-liquid transition (i.e. melting point temperature, Tₘ) and the glass-liquid transition (i.e. glass transition temperature, T_{g}). In the temperature range between these two transitions there may be a mixture of orderly arranged crystals and chaotic amorphous polymer domains. The glass transition temperature, Tg, is the temperature at atmospheric pressure at which the amorphous domains of a polymer change from a brittle vitreous state to a solid deformable or ductile state. At temperatures above the Tg segmental motion of the polymer chains occur. It is desirable to maintain high strength and limit creep or recoil of the stents disclosed herein for proper function. For this purpose it is desirable to use polymers with a Tg greater than body temperature.

Molecular orientation of the polymer chains in the processes of the present invention can be obtained, for example, in the following manner: The polymer stent having diameter A is heated to a sufficiently effective temperature above the T_{g} of the polymer for a sufficiently effective period of time, preferably about 10-20° C. above the T_{g} and for example preferably for approximately 10 seconds while mounted on a radial expansion device, such as a balloon catheter, expanding pins, tapered mandrels and the like. Any known means of heating may be used including but not limited to a heated water bath, heated inert gas, such as nitrogen, and heated air. The tubing is then radially expanded to a diameter B. Those skilled in the art are aware of a variety of means to affect expansion such as mandrels, balloon, or pressurized fluids, etc. Radial expansion can be performed while constrained within a mold to maintain the desired diameter B of the tubing, or the tubing can be expanded while unconstrained. Diameter B is less than the final diameter C upon implantation or deployment of the stent into the body lumen. The tubing is then cooled to below the T_{g} of the polymer through any known means (ice bath, cooled N2 or air, etc.).

The polymer tubing may be prepared from polymeric materials such as biocompatible, bioabsorbable or nonabsorbable polymers. The selection of the polymeric material used to prepare the polymeric tubing according to the invention is selected according to many factors including, for example, the desired absorption times and physical properties of the materials, and the geometry of the intraluminal stent. Examples of nonabsorbable polymers include polyolefins, polyamides, polyesters, fluoropolymers, and acrylics. Biocompatible, bioabsorbable and/or biodegradable polymers consist of bulk and surface erodable materials. Surface erosion polymers are typically hydrophobic with water labile linkages. Hydrolysis tends to occur fast on the surface of such surface erosion polymers with no water penetration in bulk. The initial strength of such surface erosion polymers tends to be low however, and often such surface erosion polymers are not readily available commercially. Nevertheless, examples of surface erosion polymers include polyanhydrides such as poly (carboxyphenoxy hexane-sebacic acid), poly (fumaric acid-sebacic acid), poly (carboxyphenoxy hexane-sebacic acid), poly (imide-sebacic acid) (50-50), poly (imide-carboxyphenoxy hexane) (33-67), and polyorthoesters (diketene acetal based polymers).

Bulk erosion polymers, on the other hand, are typically hydrophilic with water labile linkages. Hydrolysis of bulk erosion polymers tends to occur at more uniform rates across the polymer matrix of the stent. Bulk erosion polymers exhibit superior initial strength and are readily available commercially.

Examples of bulk erosion polymers include poly (α-hydroxy esters) such as poly(lactide), poly(glycolide), poly(caprolactone), poly (p-dioxanone), poly(trimethylene carbonate), poly(oxaesters), poly(oxaamides), and their co-polymers and blends. “Poly(glycolide)” is understood to include poly(glycolic acid). “Poly(lactide)” is understood to include polymers of L-lactide, D-lactide, meso-lactide, blends thereof, and lactic acid polymers. Some commercially readily available bulk erosion polymers and their commonly associated medical applications include poly (dioxanone) [PDS® suture available from Ethicon, Inc., Somerville, N.J.], poly(glycolide) [Dexon® sutures available from United States Surgical Corporation, North Haven, Conn.], poly(lactide)-PLLA [bone repair], poly(lactide/glycolide) [Vicryl® (10/90) and Panacryl® (95/5) sutures available from Ethicon, Inc., Somerville, N.J.], poly(glycolide/caprolactone (75/25) [Monocryl® sutures available from Ethicon, Inc., Somerville, N.J.], and poly(glycolide/trimethylene carbonate) [Maxon® sutures available from United States Surgical Corporation, North Haven, Conn.].

Other bulk erosion polymers are tyrosine derived poly amino acid [examples: poly (DTH carbonates), poly(arylates), and poly(imino-carbonates)], phosphorous containing polymers [examples: poly(phosphoesters) and poly(phosphazenes)], poly(ethylene glycol) [PEG] based block co-polymers [PEG-PLA, PEG-poly(propylene glycol), PEG-poly(butylene terephthalate)], poly (α-malic acid), poly(ester amide), and polyalkanoates [examples: poly(hydroxybutyrate (HB) and poly(hydroxyvalerate) (HV) co-polymers].

Of course, the polymer tubing may be made from combinations of surface and bulk erosion polymers in order to achieve desired physical properties and to control the degradation mechanism. For example, two or more polymers may be blended in order to achieve desired physical properties and stent degradation rate. Alternately, the polymer tubing may be made from a bulk erosion polymer that is coated with a surface erosion polymer.

In some embodiments, the polymeric tubing or stent provided may be comprised of blends of polymeric materials, blends of polymeric materials and plasticizers, blends of polymeric materials and therapeutic agents, blends of polymeric materials and radiopaque agents, blends of polymeric materials with both therapeutic and radiopaque agents, blends of polymeric materials with plasticizers and therapeutic agents, blends of polymeric materials with plasticizers and radiopaque agents, blends of polymeric materials with plasticizers, therapeutic agents and radiopaque agents, and/or any combination thereof. By blending materials with different properties, a resultant material may have the beneficial characteristics of each independent material. For example, stiff and brittle materials may be blended with soft and elastomeric materials to create a stiff and tough material. In addition, by blending either or both therapeutic agents and radiopaque agents together with the other materials, higher concentrations of these materials may be achieved as well as a more homogeneous dispersion. Various methods for producing these blends include solvent and melt processing techniques.

The polymer tubing is then processed to provide a stent with the desired stent configuration by cutting the tubing to the desired length and then machining to obtain the desired geometric configuration. Machining of the stent may be accomplished by conventional methods such as laser cutting. In one embodiment, the stent having diameter A may be obtained by other methods, such as injection molding rather than machining from polymer tubing.

The method of manufacturing a polymeric intraluminal stent is not limited by the stent geometric configuration, but the degree and location of molecular orientation is specific to the particular stent configuration used and how it mechanically expands. Different configurations may undergo different amounts and locations of molecular orientation while undergoing the same amount of radial expansion during orientation. The methods described herein allow the use of stent configurations that cannot be used with conventional metal stents. The following non-limiting embodiments reflect just a few of the stent configurations that may be provided in the stents prepared by the methods of the invention.

In one embodiment, a stent of the present invention has a plurality of hoop components aligned in spaced apart relationship along a longitudinal axis. Each hoop component is formed from a series of alternating substantially longitudinally oriented strut members and connector junction strut members circumferentially arranged about the longitudinal axis, whereas each longitudinal strut member is connected to the circumferentially adjacent connector junction strut member by alternating arc members. At least one substantially straight connector connects adjacent hoop components between corresponding connector strut members at a connector junction.

In another embodiment, the stent comprises a plurality of hoop components interconnected by a plurality of connectors. The hoop components are formed as a continuous series of substantially longitudinally (axially) oriented radial strut members, connector junction struts and alternating substantially circumferentially oriented radial arc members. The geometry of the struts and arcs is such that when the stent is expanded, the majority of the deformation (strain) occurs in the radial arcs. Furthermore, the connectors and connector junction struts are arranged such that they do not intersect or interfere with the radial arcs.

Each of the stent configurations may also have reservoirs or wells within the struts or connectors in areas of low stress and strain such that the reservoirs or wells substantially retain their shape upon orientation or deployment.

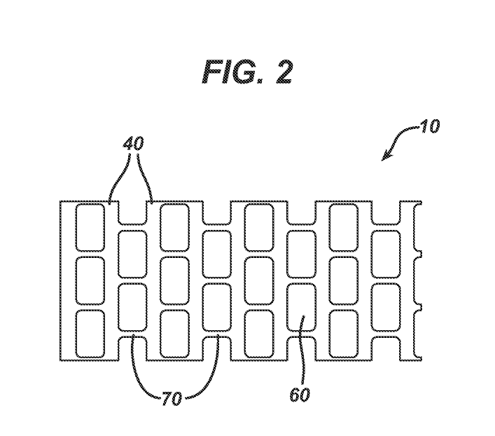

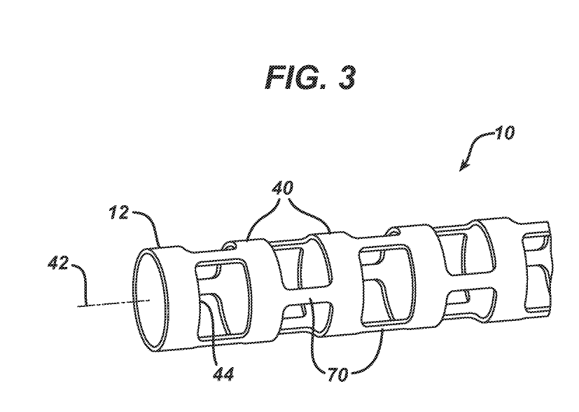

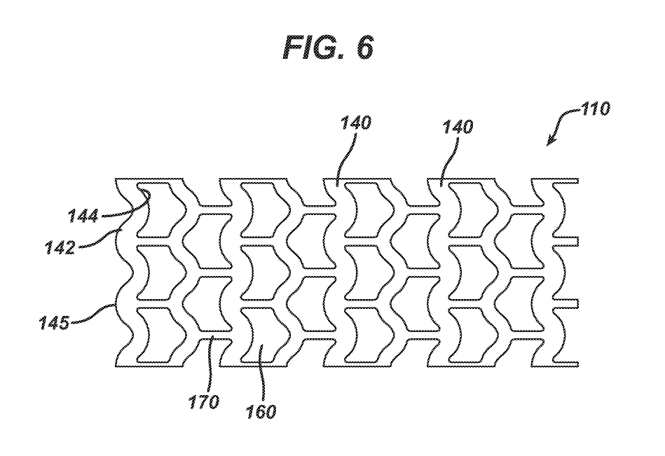

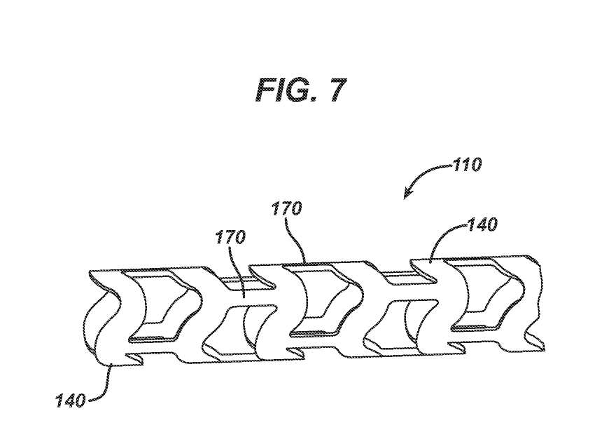

In one embodiment as illustrated in FIGS. 2 and 3, the stent 10 is a circumferential ring configuration having a longitudinal arrangement of closed circumferential ring members 40 that are substantially tubular cross-sections that are connected together by at least one bridging element or member 70 and having spaces 60. The circumferential ring member 40 is devoid of interconnecting strut geometries and is devoid of spaces within the band to help afford material deformation. A circumferential ring member 40 herein is distinct from a helical ring or band that also may encircle around the longitudinal axis of the stent but does not fully enclose to form a closed ring at a cross section of the stent. The circumferential ring members 40 provide a mechanically stable support for the body lumen. Each circumferential ring member 40 has two lateral sides 42 and 44 defining the width of the ring, the lateral sides 42 and 44 are generally parallel with one another and span the circumference 12 of the stent 10 as a closed ring. The two lateral sides 42 and 44 may be generally straight or may have a wave-like pattern or other material protrusion as seen in FIGS. 6 and 7 so long as at least one cross sectional plane within the ring is a continuous closed ring. The circumferential ring configuration does not have any hinge points that can relax and contribute to stent recoil. As seen in FIGS. 6 and 7, a wavy circumferential ring 140 of the stent 110 effectively provides increased material in the circumferential ring member 140 without increasing the diameter of the device, such as protrusion 145. The increased material in the ring member 140, allows the ring member 140 to be deformed to a larger diameter before the ring member 140 is fully plastically deformed. The larger diameter increases the hoop stresses in the material thereby allowing lower radial pressures to be used, thus facilitating expansion in the body without needing to increase the overall diameter of the device itself.

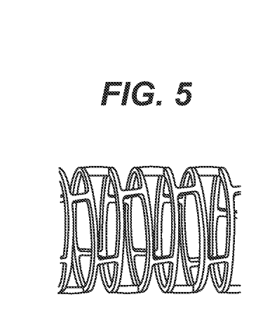

Adjacent circumferential rings are connected together by at least one bridging element. The bridging element may be substantially straight or maybe wave-like. Those skilled in the art are aware of many known bridge geometries that may be used without straying from the scope of this invention. The number and location of the bridging elements contributes toward the stent flexibility. The number and width of the spaces between adjacent circumferential rings helps control the amount of axial and longitudinal flexibility desired. Generally more rings and larger spacing between circumferential rings would lend itself to a more flexible configuration. FIG. 2 and FIG. 3 show an embodiment of a stent 10 where three straight bridging elements or members 70 are used to connect adjacent circumferential rings or ring members 40, the bridging elements 70 being equispaced in their attachment points to the ring members 40 with adjacent bridging alternating by 120 degrees around the circumference 12. FIG. 2 shows a 2-D planar rendering of a circumferential ring configuration to produce a stent with an OD=1.0 mm, ID =0.64 mm, strut width=0.2 mm, spacing between rings=0.75 mm with three connectors between adjacent rings. The locations of bridge elements in subsequent ring sections alternate to provide for improved axial flexibility. FIG. 5 is a microscopic image of a deployed polymeric stent manufactured by the process of the present invention and having an exemplary circumferential ring configuration as shown in FIG. 3. The stent was laser cut from 0.049″ OD diameter polymer tubing with a wall thickness of roughly 0.012″ The laser cut stent was then radially expanded to a larger diameter (while above the Tg of the material) to induce circumferential orientation in the stent. The stent was then mounted on a 3.5 mm balloon catheter, heated for 1 minute in a 37° C. water bath and deployed to size at 10 atm pressure. Those skilled in the art will soon recognize that the number of rings, thickness and width of rings can vary depending on the radial strength and flexibility desired without straying from the scope of the invention. Those skilled in the art will also recognize other bridging element geometries (other than straight connections) and variable numbers of elements and spacings can also be devised without straying from the scope of the invention.

Although the circumferential rings or ring members 40 are generally solid, the stent 10 configuration can accommodate reservoirs in regions of low strain or deformaton within the ring, in material protruding from the side of a ring or in the bridging elements. Reservoirs are useful to house agents, including but not limited to therapeutic agents, radiopaque agents, and the like. Either or both parallel sides of a ring can have attached protrusions or waviness incorporated (extended into the space between adjacent rings) that also may contain reservoirs. Such a location may be desirable to avoid deformation of the reservoir during expansion of the stent.

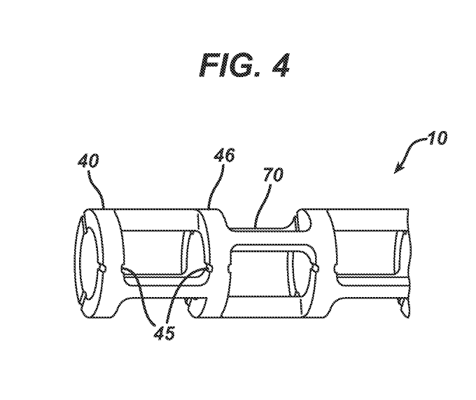

In one embodiment as illustrated in FIG. 4 the circumferential ring member 40 of stent 10 may have necked down regions 45. The necked down regions, created by reducing the width of the ring member 40 in certain areas, serve as regions where strain is localized to allow deformation (and potential subsequent stent recoil) only in certain regions of the device. The stent may be equipped with reservoirs in low strain regions of the stent which are generally in the bridge regions or perhaps in extra material protruding from either side of a circumferential ring where deformation may be minimal. The localized strain regions 45 (FIG. 4) (necked down geometry) along the circumference of the ring member 40 to focus stress and strain in confined region in an effort focus strain and potential deformation and recoil to certain areas. Between adjacent circumferential rings is at least one bridging element which may have various geometries, a straight bridging element being the simplest geometry.

Such circumferential ring stent configurations are inherently strong and stiff compared to traditional undulating strut and hinge configurations. The circumferential rings are devoid of strut unfolding and are thus a more compact longitudinal arrangement of circumferential rings can be achieved along the length of the stent compared to traditional columns of undulating strut geometries. Not only are the solid rings inherently strong due to their continuous geometry but more circumferential rings per unit length of the stent can be achieved compared to traditional stent configurations having unfolding struts which contribute greatly to the overall radial strength of the stent in resisting external loads. Due to the improved strength per unit length of the stent, the stent can be made thinner which is beneficial for improved blood flow and enables the use of less material in the body. A further advantage is that component of recoil due to the mechanical relaxation of unfolding struts in traditional stent configurations with hinges is eliminated. Any resultant recoil would be limited to that of material relaxing from its plastically deformed shape. The following are non-limiting embodiments of circumferential ring configurations.

In another embodiment, the stent comprises a plurality of circumferential rings or sections spaced apart in relationship along a longitudinal axis. Each circumferential ring is formed from a continuous tubular section devoid of individual struts in geometric relation to one another. Each tubular section, although generally cylindrical can be also contain protrusions on either longitudinal side of the circumferential ring. Being that such protrusions or extra material extend on either side of the ring section, they are regions of relatively lower strain and stress and can be used to house reservoirs with minimal risk of deforming during deployment. At least one substantially straight bridging element or connector connects adjacent circumferential ring sections. Within the bridging elements which lie generally longitudinally, can also contain reservoirs since the bridging elements are regions of relatively low stress and strain during deployment.

The method described herein provides unique properties such as enhanced toughness and strength achieved through molecular orientation of the stent geometry. Such polymeric intraluminal stents are able to withstand a broader range of loading conditions than currently available polymeric stents. More particularly, the molecular orientation designed into the polymer facilitates the use of stent configurations that typically cannot be achieved with traditional metal stents (too stiff to deform with strut geometries) or unoriented polymers with a Tg higher than body temperature (too brittle and weak to avoid cracking during deployment).

The intraluminal stents prepared by the methods of the invention herein described may be utilized for any number of medical applications, including vessel patency devices, such as vascular stents, biliary stents, ureter stents, vessel occlusion devices such as atrial septal and ventricular septal occluders, patent foramen ovale occluders and orthopedic devices such as fixation devices. The stent may be used for the controlled release of therapeutic agents and the stent may have a radioopaque agent.

In one embodiment, plasticizers suitable for use in the present invention may be selected from a variety of materials including organic plasticizers and those like water that do not contain organic compounds. Organic plasticizers include but not limited to, phthalate derivatives such as dimethyl, diethyl and dibutyl phthalate; polyethylene glycols with molecular weights preferably from about 200 to 6,000, glycerol, glycols such as polypropylene, propylene, polyethylene and ethylene glycol; citrate esters such as tributyl, triethyl, triacetyl, acetyl triethyl, and acetyl tributyl citrates, surfactants such as sodium dodecyl sulfate and polyoxymethylene (20) sorbitan and polyoxyethylene (20) sorbitan monooleate, organic solvents such as 1,4-dioxane, chloroform, ethanol and isopropyl alcohol and their mixtures with other solvents such as acetone and ethyl acetate, organic acids such as acetic acid and lactic acids and their alkyl esters, bulk sweeteners such as sorbitol, mannitol, xylitol and lycasin, fats/oils such as vegetable oil, seed oil and castor oil, acetylated monoglyceride, triacetin, sucrose esters, or mixtures thereof. Preferred organic plasticizers include citrate esters; polyethylene glycols and dioxane.

In one embodiment, therapeutic agent or agents are combined with the polymeric intraluminal stent. Examples of therapeutic agents include but are not limited to: anti-proliferative/antimitotic agents including natural products such as vinca alkaloids (i.e. vinblastine, vincristine, and vinorelbine), paclitaxel, epidipodophyllotoxins (i.e. etoposide, teniposide), antibiotics (dactinomycin (actinomycin D) daunorubicin, doxorubicin and idarubicin), anthracyclines, mitoxantrone, bleomycins, plicamycin (mithramycin) and mitomycin, enzymes (L-asparaginase which systemically metabolizes L-asparagine and deprives cells which do not have the capacity to synthesize their own asparagines); antiplatelet agents such as G(GP) ll_{b}/lllₐ inhibitors and vitronectin receptor antagonists; anti-proliferative/antimitotic alkylating agents such as nitrogen mustards (mechlorethamine, cyclophosphamide and analogs, melphalan, chlorambucil), ethylenimines and methylmelamines (hexamethylmelamine and thiotepa), alkyl sulfonates-busulfan, nirtosoureas (carmustine (BCNU) and analogs, streptozocin), trazenes-dacarbazinine (DTIC); anti-proliferative/antimitotic antimetabolites such as folic acid analogs (methotrexate), pyrimidine analogs (fluorouracil, floxuridine and cytarabine) purine analogs and related inhibitors (mercaptopurine, thioguanine, pentostatin and 2-chlorodeoxyadenosine {cladribine}); platinum coordination complexes (cisplatin, carboplatin), procarbazine, hydroxyurea, mitotane, aminoglutethimide; hormones (i.e. estrogen); anti-coagulants (heparin, synthetic heparin salts and other inhibitors of thrombin); fibrinolytic agents (such as tissue plasminogen activator, streptokinase and urokinase), aspirin, dipyridamole, ticlopidine, clopidogrel, abciximab; antimigratory; antisecretory (breveldin); anti-inflammatory; such as adrenocortical steroids (cortisol, cortisone, fludrocortisone, prednisone, prednisolone, 6α-methylprednisolone, triamcinolone, betamethasone, and dexamethasone), non-steroidal agents (salicylic acid derivatives i.e. aspirin; para-aminophenol derivatives i.e. acetaminophen; indole and indene acetic acids (indomethacin, sulindac, and etodalec), heteroaryl acetic acids (tolmetin, diclofenac, and ketorolac), arylpropionic acids (ibuprofen and derivatives), anthranilic acids (mefenamic acid, and meclofenamic acid), enolic acids (piroxicam, tenoxicam, phenylbutazone, and oxyphenthatrazone), nabumetone, gold compounds (auranofin, aurothioglucose, gold sodium thiomalate); immunosuppressives: (cyclosporine, tacrolimus (FK-506), sirolimus (rapamycin), everolimus, azathioprine, mycophenolate mofetil); angiogenic agents: vascular endothelial growth factor (VEGF), fibroblast growth factor (FGF); angiotensin receptor blockers; nitric oxide donors, antisense oligionucleotides and combinations thereof; cell cycle inhibitors, mTOR inhibitors, and growth factor receptor signal transduction kinase inhibitors; retenoids; cyclin/CDK inhibitors; HMG co-enzyme reductase inhibitors (statins); and protease inhibitors.

The therapeutic agents may be incorporated into the stent in different ways. For example, the therapeutic agents may be coated onto the stent, after the stent has been formed, wherein the coating is comprised of polymeric materials into which therapeutic agents are incorporated. There are several ways to coat the stents that are disclosed in the prior art. Some of the commonly used methods include spray coating; dip coating; electrostatic coating; fluidized bed coating; and supercritical fluid coatings. Alternately, the therapeutic agents may be incorporated into the polymeric materials comprising the stent. The therapeutic agent can be housed in reservoirs or wells in the stent configuration. These various techniques of incorporating therapeuic agents into, or onto, the stent may also be combined to optimize performance of the stent, and to help control the release of the therapeutic agents from the stent.

In another embodiment, radiopaque agents may be combined with the polymeric intraluminal stent. Because visualization of the stent as it is implanted in the patient is important to the medical practitioner for locating the stent, radiopaque agents may be added to the stent, which as described herein is a polymeric intraluminal stent. The radiopaque agents may be added directly to the polymeric materials comprising the stent during processing thereof resulting in fairly uniform incorporation of the radiopaque agents throughout the stent. The therapeutic agent can be housed in reservoirs or wells in the stent configuration. Alternately, the radiopaque agents may be added to the stent in the form of a layer, a coating, a band or powder at designated portions of the stent depending on the geometry of the stent and the process used to form the stent. Coatings may be applied to the stent in a variety of processes known in the art such as, for example, chemical vapor deposition (CVD), physical vapor deposition (PVD), electroplating, high-vacuum deposition process, microfusion, spray coating, dip coating, electrostatic coating, or other surface coating or modification techniques. Such coatings sometimes have less negative impact on the physical characteristics (e.g., size, weight, stiffness, flexibility) and performance of the stent than do other techniques. Preferably, the radiopaque material does not add significant stiffness to the stent so that the stent may readily traverse the anatomy within which it is deployed. The radiopaque material should be biocompatible with the tissue within which the stent is deployed. Such biocompatibility minimizes the likelihood of undesirable tissue reactions with the stent

The radiopaque agents may include inorganic fillers, such as barium sulfate, bismuth subcarbonate, bismuth oxides and/or iodine compounds. The radiopaque agents may instead include metal powders such as tantalum, tungsten or gold, or metal alloys having gold, platinum, iridium, palladium, rhodium, a combination thereof, or other materials known in the art. Preferably, the radiopaque agents adhere well to the stent such that peeling or delamination of the radiopaque material from the stent is minimized, or ideally does not occur. Where the radiopaque agents are added to the stent as metal bands or discs, the metal bands or discs may be crimped at designated sections of the stent. Alternately, designated sections of the stent may be coated with a radiopaque metal powder, whereas other portions of the stent are free from the metal powder. The particle size of the radiopaque agents may range from nanometers to microns, preferably from less than or equal to 1 micron to about 5 microns, and the amount of radiopaque agents may range from 0-99 percent (wt percent).

The following examples are illustrative of the principles and practice of this invention, although not limited thereto. Numerous additional embodiments within the scope and spirit of the invention will become apparent to those skilled in the art once having the benefit of this disclosure.

### EXAMPLE 1

Polymer tubing made of 85/15 (mol/mol) poly(lactide-co-glycolide) (PLGA) (Purac International, Netherlands) was extruded with an outer diameter (OD) of 1.25 mm and an inner diameter (ID) of 0.61 mm Stents having circumferential ring configurations, such as those shown in FIG. 3, were laser cut from the tubing using a low energy laser. The stents were radially expanded by mounting on a 1.5 mm balloon catheter and heating the assembly for 10 seconds at 70° C. (>T_{g}) followed by expanding the balloon to a pressure of 10 atm, thereby circumferentially orienting the stent. The partially expanded stent was then mounted on a 3.0 mm balloon catheter and heated for 10 seconds at 70° C. (>T_{g}) prior to balloon expansion to 6 atm and then cooled to below the T_{g}. The two expansion processes served the purpose of effectively orienting the stents to have the degree of orientation and wall thickness that it would allow successful deployment at body temperature (37° C.). The resulting stents were then mounted onto a 3.5 mm balloon catheter and expanded with approximately 15 atm of catheter pressure while in a 37° C. water bath. The stents were deployed successfully without cracking or crazing as is shown in FIG. 5.

### EXAMPLE 2

Polymer tubing was extruded from 85/15 (mol/mol) poly(lactide-co-glycolide) (PLGA) (Purac International, Netherlands) having an outer diameter (OD) of 1.25 mm and an inner diameter (ID) of 0.61 mm. (The tubing was cut into a stent configuration such as shown in FIG. 4 and mounted on a 1.5 mm balloon catheter. The assembly was inserted into a 0.057″ tube mold which was heated to 70° C. for 1 minute, at which time the balloon was inflated to 3-4 atm. At this size the mold was cooled with ice water. The stent was released from the mold at the 1.45 mm OD size. The oriented stent was first dried in N₂ and then mounted onto a 3.5 mm balloon dilatation catheter for deployment test. The assembly was heated at 37° C. in a water bath for 1 minute prior to being inflated to 8 atm (nominal rating) to expand the stent to 4.0 mm OD size. The stent expanded with no evidence of crazing or cracking. The material showed tremendous resilience and plastic deformation as the struts were pulled.

### EXAMPLE 3

Endovascular stent surgery is performed in a cardiac catheterization laboratory equipped with a fluoroscope, a special x-ray machine and an x-ray monitor that looks like a regular television screen. The patient is prepared in a conventional manner for surgery. For example, the patient is placed on an x-ray table and covered with a sterile sheet. An area on the inside of the upper leg is washed and treated with an antibacterial solution to prepare for the insertion of a catheter. The patient is given local anesthesia to numb the insertion site and usually remains awake during the procedure. A polymer stent having a configuration as shown in FIG. 3 is prepared by methods described in herein having an outside diameter of approximately 1.45 mm and a wall thickness of approximately 100 microns is mounted onto a traditional 3.0 mm balloon dilatation catheter. To implant a stent in the artery, the catheter is threaded through an incision in the groin up into the affected blood vessel on a catheter with a deflated balloon at its tip and inside the stent. The surgeon views the entire procedure with a fluoroscope. The surgeon guides the balloon catheter to the blocked area and inflates the balloon, usually with saline to about 10 atm or according to instructions for use of the catheter, causing the stent to expand and press against the vessel walls. The balloon is then deflated and taken out of the vessel. The entire procedure takes from an hour to 90 minutes to complete. The stent remains in the vessel to hold the vessel wall open and allow blood to pass freely as in a normally functioning healthy artery. Cells and tissue will begin to grow over the stent until its inner surface is covered.

The above descriptions are merely illustrative and should not be construed to capture all consideration in decisions regarding the optimization of the configuration and material orientation. It is important to note that although specific configurations are illustrated and described, the principles described are equally applicable to many already known stent configurations. Although shown and described is what is believed to be the most practical and preferred embodiments, it is apparent that departures from specific configurations and methods described and shown will suggest themselves to those skilled in the art and may be used without departing from the spirit and scope of the invention. The present invention is not restricted to the particular constructions described and illustrated, but should be constructed to cohere with all modifications that may fall within the scope for the appended claims.

What is claimed is:

1. A method of manufacturing polymer stents comprising the steps of:
a. providing a polymer tubing having a diameter A;
b. cutting a stent from the polymer tubing; and
c. orienting the stent having a diameter A by expanding the stent to a diameter B.

2. A method of manufacturing polymer stents, comprising
a. providing a polymeric stent wherein the stent comprises a polymer having a Tg;
b. orienting the molecular structure of the stent by heating the stent above the Tg of a polymer for a sufficiently effective period of time;
c. radially expanding the stent to diameter B; and,
d. cooling the stent to below the Tg, wherein diameter B is greater than diameter A.
